(19) United States
(12) Patent Application Publication
(10) Pub. No.: US 2025/0388484 A1
(43) Pub. Date: Dec. 25, 2025

(54) UNCONVENTIONAL PHASE HEXAGONAL PRUSSIAN BLUE ANALOGS WITH OPEN STRUCTURES

(71) Applicant: City University of Hong Kong, Hong Kong (HK)

(72) Inventors: Zhanxi FAN, Hong Kong (HK); Jinwen YIN, Hong Kong (HK)

(21) Appl. No.: 18/748,123

(22) Filed: Jun. 20, 2024

(51) Int. Cl. C01G 51/00; C01C 3/00; C01G 3/00

(52) U.S. Cl. CPC C01G 51/82; C01C 3/003; C01G 3/006; C01P 2004/03; C01P 2004/40; C01P 2006/12; C01P 2006/16

(57) ABSTRACT

The present invention relates to a facile synthetic method to synthesize novel hexagonal phase CuCo (H—CuCo) PBAs with high crystallinity, as well as extended synthesis of doping PBAs with hexagonal phase: Fe_{0.1}—CuCo, Fe_{0.2}—CuCo, Co_{0.1}—CuCo, Ni_{0.1}—CuCo, and Zn_{0.1}—CuCo. The hexagonal phase H—CuCo PBAs and the doping sequence of PBAs with hexagonal phase exhibit superior crystallinity and significantly higher intrinsic specific surface area. Meanwhile, H—CuCo PBAs show great potential for gas adsorption and have a positive impact on the development of PBAs for other applications.

### FIELD OF THE INVENTION

The present invention pertains to the field of materials science and chemistry, specifically synthetic chemistry and materials synthesis techniques.

### BACKGROUND OF THE INVENTION

As a family member of microporous inorganic solids, the well-known Prussian blue (PB) and its analogs (PBAs) show promising potential in lots of fields such as catalysis, gas storage, energy storage, photothermal therapy, drug delivery, sensor, nanozyme, etc. Conventional PBAs are octahedral [M′(CN)₆]ⁿ⁻ complexes, which are linked via octahedrally-coordinated, nitrogen-bound Mⁿ⁺ ions, and corresponded to the cubic structure (Fm3̅m space group, cubic system, lattice form is face-centered cube), such as Cu₃[Co(CN)₆]₂, always associated with M[M′(CN)₆]ⁿ⁻ vacancies, in which M and M′ normally are early transition metal (M=Cu, Co, Ni, Fe, Zn, etc., M′=Mn, Fe, Co). They can serve to maintain electrical neutrality.

In order to achieve specific requirements, defect engineering is often applied to regulate PBAs, by creating [M′(CN)₆] or cyanogen (CN) defect (FIG. 1). However, the distribution of defects is non-periodic and random, posing a significant obstacle to studying the crystal structure at the atomic scale. Particularly challenging is the growth of single crystals of PBAs due to the rapid formation of microcrystalline structures during synthesis. Furthermore, the presence of defects renders the PBA structure brittle and prone to collapse. Furthermore, the low intrinsic specific surface area of conventional cubic PBAs poses a significant obstacle to the development of PBA applications. This limitation is particularly critical as many applications are highly dependent on the specific surface area of PBAs, such as gas storage. Hence, developing a new synthesis strategy to control the crystallinity and increase the specific surface area of PBAs is crucial to promote their development.

Phase engineering is recognized as an effective method for controlling crystal structure, which can significantly impact the chemical and physical properties of materials. This approach involves manipulating factors such as atomic arrangements, electronic structures, and coordination numbers. Phase engineering has been successfully applied to various materials, including metals, metal oxides, IVA group metal chalcogenides, and transition metal dichalcogenides (TMDs).

Pal, Shyam Chand et al.¹ discloses that cubic CuCo PBA having promising potential for CO₂ adsorption, as well as CO₂/CH₄ separation via breakthrough simulation study. However, practical CO₂/CH₄ separation by PBAs had not published yet.

Based on the preceding discussion, an important breakthrough still missing in the field is the development of a new synthesis strategy that can overcome the defects of PBAs, enhance control over their crystal structure, and increase their specific surface area.

### SUMMARY OF THE INVENTION

The present invention aims to address the limitations of conventional Prussian blue analogs (PBAs) by developing a new synthesis strategy that enhances control over the crystal structure, increases the specific surface area, and improves the small molecular adsorption capacity including CO₂. Furthermore, the invention aims to achieve practical CO₂/CH₄ separation and the C₃H₆/C₂H₄ separation using PBAs.

In a first aspect, the present invention provides a hexagonal phase copper-cobalt Prussian blue analog material, which includes 30-40 wt % of copper, 10-30 wt % of cobalt, 10-30 wt % of carbon and 10-30 wt % of nitrogen. Each copper ion is coordinated with four cyanogen groups showing a plane quadrilateral configuration, while each copper ion is connected with six cyanogen groups showing an octahedral configuration.

In an embodiment, the hexagonal phase copper-cobalt Prussian blue analog material is capable of forming prism-shaped crystals.

In an embodiment, the hexagonal phase copper-cobalt Prussian blue analog material has a 20 value of 13.9°, 14.4°, 16.0°, 20.1°, 21.7°, 22.1°, 23.2°, 25.1°, 25.5°, 26.2°, 29.1°, 29.9°, 31.1°, 32.4°, 36.1°, 37.1°, 37.9°, 38.8°, 39.5°, 40.8°, 41.7°, 44.9°, 45.8°, 46.2°, 47.1°, 50.2°, 51.6°, 52.4°, 53.2°, 53.9°, 55.3°, 57.5°, 57.8°, 58.9°, 61.2°, 61.7°, 62.9°, 64.0°.

In an embodiment, the hexagonal phase copper-cobalt Prussian blue analog material exhibits stacking disorders in a hexagonal lattice structure.

In an embodiment, the hexagonal phase copper-cobalt Prussian blue analog material has a specific surface area of at least 1000 m² g⁻¹.

Preferably, the hexagonal phase copper-cobalt Prussian blue analog material has a specific surface area of at least 1200 m² g⁻¹.

In an embodiment, the hexagonal phase copper-cobalt Prussian blue analog material has larger channels and interstitial spaces for metal-ion storage and diffusion.

In an embodiment, the hexagonal phase copper-cobalt Prussian blue analog material exhibits three types of pores with half pore widths of 2.74, 4.30, and 6.16 Å.

In an embodiment, numerous unsaturated copper sites are present within a framework of hexagonal phase copper-cobalt.

In an embodiment, numerous Cu^{I} and a low coordination number of Cu—N≡C—Co are presented in hexagonal phase copper-cobalt Prussian blue analog material.

In an embodiment, the hexagonal phase copper-cobalt Prussian blue analog material demonstrates a gas adsorption performance that is at least 1.5 times higher than that of cubic PBAs.

In an embodiment, the gas includes CO₂, CH₄, C₂H₂, C₂H₄, C₂H, C₃H, and C₃H₈.

In an embodiment, the hexagonal phase copper-cobalt Prussian blue analog material demonstrates superior separation performance for C₃H₆/C₂H₄ and CO₂/CH₄ compared to a cubic Prussian blue analog material.

In another embodiment, the hexagonal phase copper-cobalt Prussian blue analog material is further doped with one or more metal precursors. The one or more metal precursors include FeCl₃, NiCl₂, or ZnCl₂, or their hydrates.

In another aspect, the present invention provides a method for synthesizing hexagonal phase copper-cobalt Prussian blue analog material, including adding DI water containing CuCl₂·2H₂O, and sodium citrate into a mixed solution of DI water and DMF dissolved K₃Co(CN)₆ and PVP to obtain a first solution; continuously stirring the first solution for 24-48 h in a 30° C. water bath; centrifugating the first solution and collecting precipitate; rinsing collected precipitate with DI water and ethanol for at least 3 times; and drying the collected sample at 80° C. for 10-15 hours. The method requires neither high-temperature treatment nor any other post-treatment.

In an embodiment, the hexagonal phase copper-cobalt Prussian blue analog material is capable of forming prism-shaped crystals.

In another embodiment, the first solution further comprises one or more metal precursors. The one or more metal precursors include FeCl₃, NiCl₂, or ZnCl₂, or their hydrates.

Through phase engineering, the present invention provides a facile and general co-precipitation method for synthesizing hexagonal phase PBA with high crystallinity, including hexagonal phase copper-cobalt (H—CuCo) PBA, and extended synthesis of doping PBAs with hexagonal phase: Co_{0.1}—CuCo, Fe_{0.1}—CuCo, Fe_{0.2}—CuCo, Ni_{0.1}—CuCo, and Zn_{0.1}—CuCo.

The hexagonal phase H—CuCo developed in the present invention possesses a higher specific surface area (1273.24 m² g⁻¹) and larger channels for metal-ion storage and diffusion. Therefore, it can exhibit better performance compared to cubic CuCo PBAs. In addition, the gas adsorption (e.g., CO₂) capacity is significantly enhanced (1.5 times higher than cubic CuCo PBAs). This breakthrough enables efficient C₃H₆/C₂H₄ and CO₂/CH₄ separation, marking a significant advancement in gas adsorption and separation technology.

### BRIEF DESCRIPTION OF THE DRAWINGS

Embodiments of the invention are described in more details hereinafter with reference to the drawings, in which:

FIG. 1 shows conventional cubic PBA with traditional vacancies engineering and novel hexagonal phase PBA by phase engineering (all water molecules and counter cations are omitted for clarity);

FIG. 2 shows a synthesis diagram of H—CuCo;

FIG. 3A depicts XRD patterns of H—CuCo and C—CuCo. FIG. 3B shows three-dimensional electron diffraction patterns. FIG. 3C depicts XPS for Co element and Cu element.

FIG. 3D depicts XPS spectrums for H—CuCo and C—CuCo;

FIG. 4A depicts 1H NMR spectrum of solution after KCl exchanged of H—CuCo.

FIG. 4B depicts TGA curves of H—CuCo and C—CuCo;

FIG. 5A shows a SEM image of H—CuCo. FIG. 5B shows a SEM image of H—CuCo.

FIG. 5C shows TEM images of H—CuCo. FIG. 5D shows a SEM image of C—CuCo. FIG. 5E shows a TEM image of C—CuCo. FIG. 5F shows a SAED image along the [11̅0] zone axis.

FIG. 5G shows HRTEM image taken from the white squared marked area in FIG. 5C, inset shows the corresponding Fast Fourier Transform (FFT) result. FIG. 5H shows a side view of the lattice structure of H—CuCo. FIG. 5I shows HAADF-STEM image and elements mapping for Cu, Co, C, N;

FIG. 6A depicts EDS spectrum of H—CuCo. Insets are the detail element ratios. FIG. 6B depicts EDS spectrum of C—CuCo. Insets are the detail element ratios;

FIG. 7A shows SEM images of Fe_{0.1}—CuCo, Fe_{0.2}—CuCo, Co_{0.1}—CuCo, Ni_{0.1}—CuCo and Zn_{0.1}—CuCo. FIG. 7B shows TEM images of Fe_{0.1}—CuCo, Fe_{0.2}—CuCo, Co_{0.1}—CuCo, Ni_{0.1}—CuCo and Zn_{0.1}—CuCo. FIG. 7C shows HAADF-STEM images of Fe_{0.1}—CuCo, Fe_{0.2}—CuCo, Co_{0.1}—CuCo, Ni_{0.1}—CuCo and Zn_{0.1}—CuCo. FIG. 7D shows XRD patterns of Fe_{0.1}—CuCo, Fe_{0.2}—CuCo, Co_{0.1}—CuCo, Ni_{0.1}—CuCo and Zn_{0.1}—CuCo;

FIG. 8 depicts XPS spectra for Cu element of Co_{0.1}—CuCo, Fe_{0.1}—CuCo, Fe_{0.2}—CuCo, Ni_{0.1}—CuCo and Zn_{0.1}—CuCo;

FIG. 9 depicts XDR patterns before and after heating at 100° C. under vacuum condition for H—CuCo and C—CuCo;

FIG. 10A depicts N₂ adsorption-desorption isotherms at 77 K of H—CuCo and C—CuCo. FIG. 10B depicts pore size distribution of H—CuCo and C—CuCo. FIG. 10C depicts gas sorption isotherms performances at 273 and 298 K, 1 bar for CO₂, CH₄, C₂H₂, C₂H, C₂H₆, C₃H₆ and C₃H₈ of H—CuCo and C—CuCo;

FIG. 11 depicts column breakthrough experiments of C₃H₆/C₂H₄ for H—CuCo and C—CuCo;

FIG. 12 depicts experimental column breakthrough curves of CO₂/CH₄ separations for H—CuCo and C—CuCo;

FIG. 13A depicts BET test results of Fe_{0.1}—CuCo, Fe_{0.2}—CuCo and Co_{0.1}—CuCo. FIG. 13B depicts CO₂ sorption performance of Fe_{0.1}—CuCo, Fe_{0.2}—CuCo and Co_{0.1}—CuCo. at 273 and 298 K. FIG. 13C depicts CH₄ sorption performance of Fe_{0.1}—CuCo, Fe_{0.2}—CuCo and Co_{0.1}—CuCo. at 273 and 298 K. FIG. 13D depicts CH₄ sorption performance of Fe_{0.1}—CuCo, Fe_{0.2}—CuCo and Co_{0.1}—CuCo. at 273 and 298 K. FIG. 13E depicts C₂H₄ sorption performance of Fe_{0.1}—CuCo, Fe_{0.2}—CuCo and Co_{0.1}—CuCo. at 273 and 298 K. FIG. 13F depicts C₂H₆ sorption performance of Fe_{0.1}—CuCo, Fe_{0.2}—CuCo and Co_{0.1}—CuCo. at 273 and 298 K. FIG. 13G depicts C₃H₆ sorption performance of Fe_{0.1}—CuCo, Fe_{0.2}—CuCo and Co_{0.1}—CuCo. at 273 and 298 K. FIG. 13H depicts C₃H₈ sorption performance of Fe_{0.1}—CuCo, Fe_{0.2}—CuCo and Co_{0.1}—CuCo. at 273 and 298 K;

FIG. 14A depicts XANES spectrum of H—CuCo, C—CuCo and the reference materials. FIG. 14B depicts Fourier transform spectra derived from EXAFS of H—CuCo, C—CuCo and the reference materials. FIG. 14C depicts WT-EXAFS spectrum of Co element for H—CuCo, C—CuCo, K₃Co(CN)₆ and Co foil. FIG. 14D depicts corresponding WT-EXAFS of Cu element for H—CuCo, C—CuCo, Cu₂O, CuO and CuPc; and

FIG. 15A depicts EXAFS fitting for Co element, K space and R space data and fitting results of H—CuCo are shown. FIG. 15B depicts EXAFS fitting for Co element K space and R space data and fitting results of C—CuCo are shown. FIG. 15C depicts EXAFS fitting for Cu element, K space and R space data and fitting results of H—CuCo are shown. FIG. 15D depicts EXAFS fitting for Cu element, K space and R space data and fitting results of C—CuCo are shown.

### DETAILED DESCRIPTION

In general, existing PBAs are fcc structure with low specific surface area and defect-rich features, which may limit the application development for PBAs. Cubic phase Prussian blue and its analogs are coordination compounds that remain stable under room temperature and pressure. PBAs hold great potential in various fields. Nevertheless, the randomly distributed defects and intrinsic characteristics of conventional cubic PBAs pose challenges to their study and development.

Therefore, the present invention provides a hexagonal phase copper-cobalt Prussian blue analog material, which includes 30-40 wt % of copper, 10-30 wt % of cobalt, 10-30 wt % of carbon and 10-30 wt % of nitrogen. Each copper ion is coordinated with four cyanogen groups showing a plane quadrilateral configuration, while each copper ion is connected with six cyanogen groups showing an octahedral configuration. The open-framework structure of PBAs includes channels and interstitial spaces that facilitate the rapid diffusion of various carrier ions and small molecules. The invention of hexagonal phase PBAs (e.g., hexagonal phase H—CuCo PBAs) not only provides a significantly higher specific surface area but also larger open channels and interstitial spaces. This allows for a greater capacity to store ions and small molecules, as well as quicker diffusion and release rates for carriers.

In one embodiment, the hexagonal phase copper-cobalt Prussian blue analog material is capable of forming prism-shaped crystals. In addition to prism-shaped crystals, the hexagonal phase copper-cobalt Prussian blue analog material can also form the following crystal shapes: rhombic crystals, hexagonal prismatic crystals, octahedral crystals, etc.

The hexagonal phase H—CuCo PBAs exhibit crystal structures with a plane configuration of Cu atoms. X-ray absorption fine structure analysis reveals numerous unsaturated Cu sites within the framework of H—CuCo.

The high crystalline H-CuCo PBAs deliver a much higher specific surface area of at least 1000 m² g⁻¹.

Preferably, the high crystalline H-CuCo delivers a much higher specific surface area of 1273.24 m² g⁻¹.

The high crystalline H-CuCo PBA achieves approximately 1.5 times gas adsorption performance than conventional cubic CuCo PBA. In particular, the CO₂ uptake capacity of the H—CuCo shows 6.09 and 4.18 mmol g⁻¹ (at 273 K and 298 K, 1 bar).

The H—CuCo PBAs also show a much better gas separation performance of C₃H₆ to C₂H₄ for 2 times of separation coefficient than cubic CuCo PBA and a breakthrough of CO₂/CH₄ separation. Such impressive performance should be attributed to the large number of unsaturated copper sites in the framework of H—CuCo PBAs.

In another aspect, the present invention provides a method for preparing H—CuCo PBAs with hexagonal phase, including:
adding DI water containing CuCl₂·2H₂O, and sodium citrate into a mixed solution of DI water and DMF dissolved K₃Co(CN)₆ and PVP to obtain a first solution;
continuously stirring the first solution for 24-48 hours in a 30° C. water bath; centrifugating the first solution and collecting precipitate;
rinsing collected precipitate with DI water and ethanol for at least 3 times; and drying the collected sample at 80° C. for 10-15 hours.

In another aspect, the present invention provides doped H—CuCo PBAs with hexagonal phase, which are made by feeding few amounts of different metal precursor. Large-scale production is feasible by proportionally increasing the concentrations of precursors, indicating high potential for industrial-level production of novel hexagonal phase H—CuCo PBAs.

In another aspect, the present invention provides a method for preparing doped H—CuCo PBAs with hexagonal phase, including: adding DI water containing CuCl₂·2H₂O, precursors of metal chlorides, and sodium citrate into a mixed solution of DI water and DMF dissolved K₃Co(CN)₆ and PVP to obtain a first solution; continuously stirring the first solution for 24-48 hours in the 30° C. water bath; collecting the precipitate by centrifugation; rinsing the collected precipitate with DI water and ethanol for at least 3 times, respectively; and drying the collected sample at 80° C. for 10-15 hours.

In one embodiment, the precursors of metal chlorides may be FeCl₃, NiCl₂, or ZnCl₂, or their hydrates.

In one embodiment, the concentration of the concentration of the precursors of metal chlorides is less than 0.04 mmol.

In one embodiment, the concentration of the sodium citrate is in a range 0.1-0.5 mmol.

In one embodiment, the ratio between DI water and DMF of the mixed solution is 2:5.

In summary, a facile and low-cost method is developed to prepare a novel hexagonal phase CuCo Prussian blue analogue (PBA) with a large amount of unsaturated Cu atoms through phase engineering. Using 3D electronic diffraction, the hexagonal lattice structure of H—CuCo can be confirmed, in which Cu ions with four cyano groups over N adopt a planar, four-sided configuration, while Co ions with six cyano groups over C form an octahedral configuration, resulting in the formation of a 12-ring pore channel. In contrast to conventional cubic structure CuCo PBAs, this hexagonal PBA exhibits significantly enhanced CO₂ adsorption performance and improved adsorption capabilities for CH₄, C₂H₂, C₂H₄, C₂H, C₃H₆, and C₃H₈. Furthermore, H—CuCo PBAs demonstrates superior separation performance for C₃H₆/C₂H₄ compared to cubic PBAs and represents a breakthrough in CO₂/CH₄ separation.

Additionally, verified by XPS and XAFS tests, a large amount of Cu^{I} and a low coordination number of Cu—N≡C—Co are found in H—CuCo PBAs, which is attributed to its unconventional hexagonal phase. This indicates that many Cu atoms in H—CuCo PBAs are unsaturated and in an open state. This is likely the reason why H—CuCo PBAs exhibit significantly better performance. In addition, a series of CuCo PBAs with a hexagonal phase dopant are developed. This doping strategy allows for the modulation of both morphology and the quantity of unsaturated Cu atoms.

In the following description, specific details are provided to offer a comprehensive understanding of the present invention, for explanatory purposes and not intended for limitation.

### Example

### Example 1

### Materials and Methods

Potassium hexacyanocobaltate (K₃Co(CN)₆, 99%), polyvinylpyrrolidone (PVP, molecular weight 58,000), cobalt chloride hexahydrate (CoCl₂·6H₂O, AR), copper chloride dihydrate (CuCl₂·2H₂O, AR), nickel chloride hexahydrate (NiCl₂·6H₂O, AR), zinc chloride (ZnCl₂, ACS Grade) and sodium citrate (Na₃C₆H₅O₇, AR, 99%) were purchased from Shanghai Aladdin. Ferric chloride hexahydrate (FeCl₃·6H₂O, AR) were purchased from Dieckmann. Ethanol (ACS Grade, absolute) was purchased from Anaqua Global International Inc. Limited. Dimethylformamide (DMF, AR) was purchased from the RCl Labscan. All the chemicals and materials were used as received without any further purification.

### Characterization

Synthesized samples were identified by the X-ray diffractometer (XRD) (SmartLab, 40 kV) with Kα rays radiated from Cu. The scanning electron microscope (SEM) samples were prepared by dropping the suspension solution onto the silicon substrate and dried under ambient conditions. The SEM images were collected on a QUATTRO S SEM operated at 20 kV. The transmission electron microscope (TEM) images were acquired on JEOL JEM-2100F. Thermogravimetry analysis (TGA) measurements were conducted on the PerkinElmer STA6000 analyzer from 30 to 650° C. at a rate of 10° C. min⁻¹ under N₂ flow.

The X-ray photoelectron spectroscopy (XPS) spectra were obtained using an ESCALAB-MKII spectrometer with an Al Kα X-ray source by using C is (284.5 eV) as the reference. The X-ray absorption spectroscopy was carried out in a transmission mode at the beamline X-ray absorption fine structure for catalysis (XAFCA) of Singapore Synchrotron Light Source operated at 700 MeV with the beam current of 200 mA. The data processing was conducted using the Athena and Artemis software packages. The solution after saturated KCl exchanged was analyzed by nuclear magnetic resonance spectroscopy (NMR 300 MHz, Bruker AVANCE III BBO Probe). The ratio of Cu to Co of H—CuCo, Co_{0.1}—CuCo, Fe_{0.1}—CuCo, Ni—CuCo were confirmed by the inductively coupled plasma optical emission spectrometry (ICP-OES, PerkinElmer, Optima 8000).

### Single Component Static Adsorption

For the porosity analysis, nitrogen adsorption-desorption experiments were executed at 77 K on an Autosorb iQ2 adsorptometer, Quantachrome Instrument. The adsorption isotherms for CO₂, N₂, etc. at 273 K and 298 K were also recorded on the same instrument. Prior to gas adsorption measurement, approximately 50 mg of the freshly-prepared samples were activated under high vacuum at 100° C. for 12 h.

### Adsorption Breakthrough Experiments

The breakthrough experiments of C₃H₆/C₂H₄ were carried out in the Multi-constituent Adsorption Breakthrough equipment at 273 K. All experiments were conducted by using a column with 6 mm inner diameter and approximately 45 nm height. The weight of the packing sample was between 0.4 to 0.6 g. The column packed with the samples were firstly activated at 100° C. for 720 min, then purged with He flow (20 mL min⁻¹) at the target temperature. The mixed gas (50/50, v/v) flow were introduced at 5 mL min⁻¹. Outlet gas from the column was monitored on-line mass spectrometry (BSD-MASS) with a thermal conductivity detector (TCD).

The breakthrough experiments of CO₂/CH₄ were conducted using a lab-scale fix-bed reactor at 298 K. In a typical experiment, the powder was activated at 373 K for 24 h. Then 100 mg of material was packed into a quartz column (5.8 mm I.D.×150 mm) with silane treated glass wool filling the void space. A helium flow (1 mL min⁻¹) was used to purge the adsorbent at 373 K for 5 h and then the system was cooled down to 298 K. The flow of helium was then turned off while the mixture of CO₂ and CH₄ (50/50, v/v) at a rate of 1 mL min⁻¹ was allowed to flow into the column. The effluent from the column was monitored using an-online mass spectrometer.

### Example 2

### Synthesis of Hexagonal Phase CuCo Prussian Blue Analog Materials (H—CuCo)

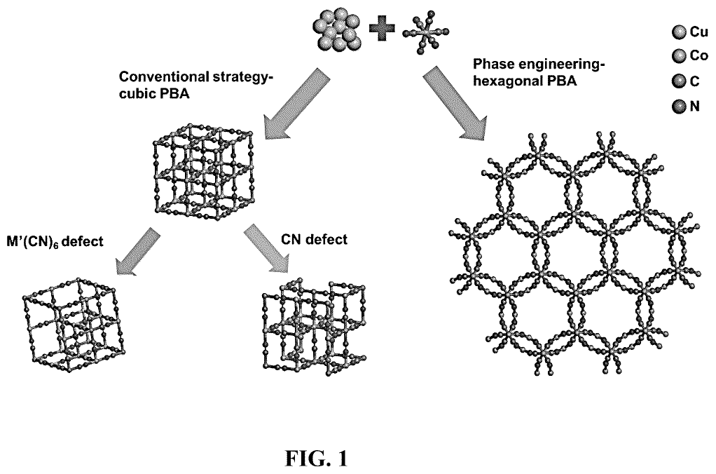

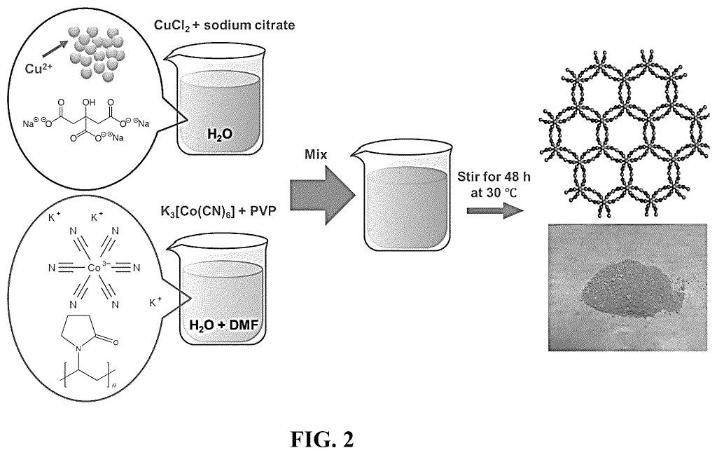

Referring to FIG. 1, instead of the conventional approach to prepare cubic PBA (C—CuCo) with or without vacancies, hexagonal phase copper-cobalt Prussian blue analog materials (referred to as H—CuCo) were synthesized using a phase-engineering strategy and a simple co-precipitation method. FIG. 2 illustrated the synthesis process of the H—CuCo, which required neither high-temperature treatment nor any other post-treatment.

For the synthesis of H—CuCo, a facile co-precipitation was applied. 5 mL of deionized (DI) water contained 0.2 mmol of CuCl₂·2H₂O and 0.2 mmol of sodium citrate was added into the mixed solution of 5 ml DI water and 25 ml DMF which dissolved 0.2 mmol of K₃Co(CN)₆ and 0.2 g of PVP. Then, the above solution was continuously stirred for 48 h in the 30° C. water bath. After the reaction completed, the precipitate was collected by centrifugation and rinsed with DI water and ethanol for 3 times, respectively. Finally, the collected sample was dried at 80° C. for 12 h.

### Synthesis of Cubic Phase CuCo PBA Cubes (C—CuCo)

15 ml of DI water dissolved 0.145 g Cu(NO₃)₂ and 0.75 mmol of sodium citrate was added into 15 ml of DI water containing 0.133 g K₃Co(CN)₆, and stirred for 12 h at ambient temperature. When the reaction finished, the precipitate was collected by centrifugation and rinsed with DI water and ethanol 3 times, respectively. Finally, the collected sample was dried at 80° C. in the oven for 12 h.

### Example 3—Characterization of the PBAs

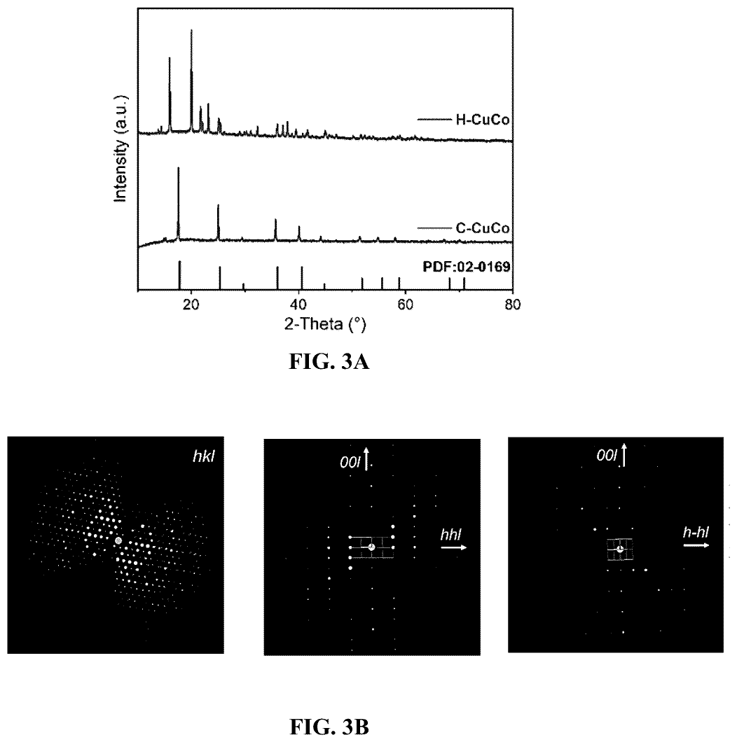

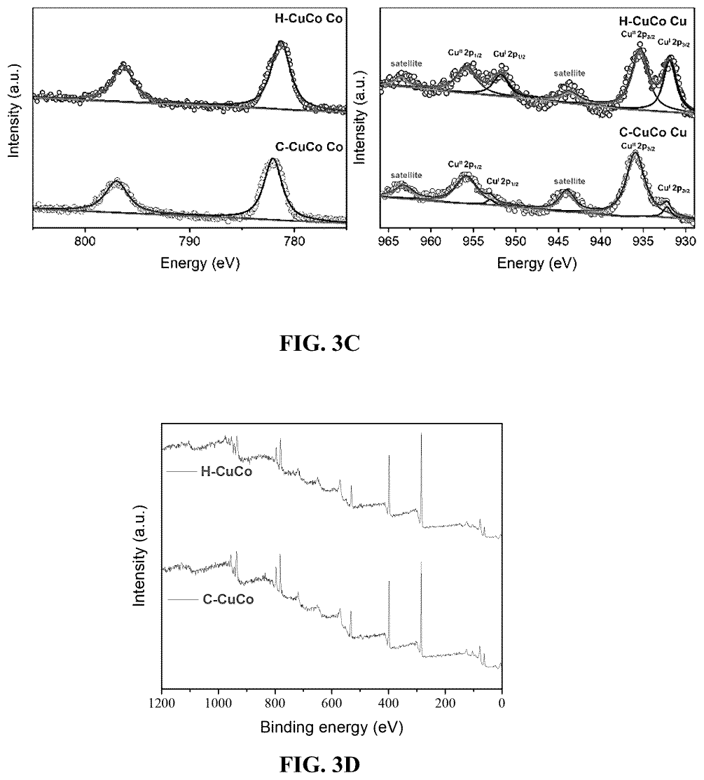

Turning to FIG. 3A, the XRD pattern showed that the XRD of C—CuCo was consistent with the traditional PBAs' pattern (Fm3m, fcc phase), whereas the XRD pattern of H—CuCo was totally different from that of C—CuCo. Both sharp and broad peaks were visible in the XRD pattern of H—CuCo, indicating the possible presence of stacking disorders in its lattice structure. Therefore, confirming the crystalline structure of H—CuCo via conventional methods was nearly impossible.

The emerging three-dimensional (3D) electron diffraction (ED) had been considered a powerful method for structure determination²⁻⁵. One of the specific methods of rotation electron diffraction (RED) had been utilized for solving initial structural models from a variety of functional crystalline materials^{2,6}. In particular, the continuous RED (cRED) could collect hundreds of ED patterns in a short time (<5 min) and low electron dose rate⁷⁻⁸, so that the cRED not only solved the initial structural models but also refined certain crystalline materials.

To precisely confirm the structure of H—CuCo, the cRED was utilized to solve the lattice structure of H—CuCo. The hexagonal CuCo PBA unit cell parameters (a=12.1 Å, b=12.1 Å, c=12.7 Å, a=90.52°, β=89.70°, and γ=119.53°) was deduced by cRED. Referring to FIG. 3B, reflection conditions were obtained from the 2D slices cut from the 3D reciprocal lattice to be h-h01: 1=2n, which led to three possible space groups: P63 cm (No. 185), P-6c2 (No. 188), and P63/mcm (No. 193).

The cRED data was further processed and intensities were extracted using the X-ray Detector Software (XDS). Ab initio structure solution was performed using the highest space group suggested by SHELXT for the initial structure solution by direct methods implanted in SHELXT⁹. There were six Cu ions, four Co ions, and twenty-four cyanogen groups within one unit cell. Each Cu ion coordinated with four cyanogen groups displaying a plane quadrilateral configuration, while each Co ion connected with six cyanogen groups showing an octahedral configuration, which was different from the conventional cubic lattice. In this instance, octahedra and quadrilaterals were connected by alternatively sharing the cyanogen group. This created a 12-ring pore channel along the c-axis, considering only the metal ions.

### Example 4—Atomic Ambient for Elements in the H—CuCo

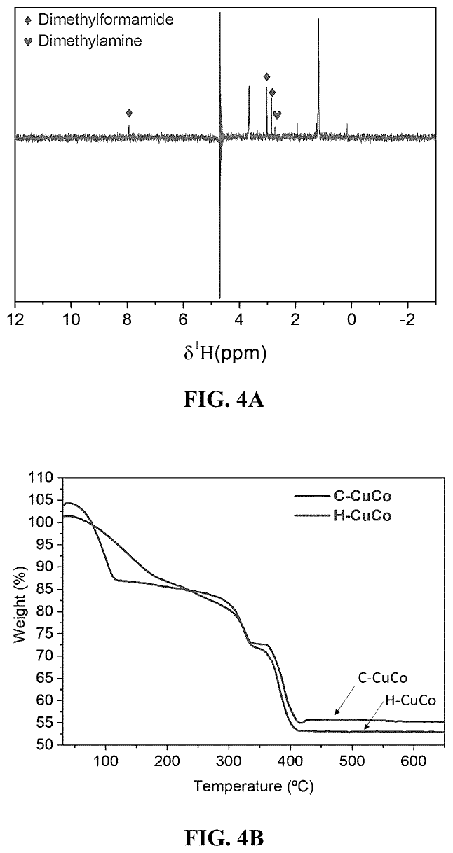

XPS was performed and the results were shown in the FIGS. 3C-3D. As shown in FIG. 3D, the entire XPS spectrum of H—CuCo was consistent with that of the traditional cubic phase C—CuCo, indicating identical compositions of Cu, Co, C, and N. Specifically, for the Co element in both H—CuCo and C—CuCo, FIG. 3C showed similar XPS patterns without a satellite peak, corresponding to Co^{III} in Co—C≡N¹⁰⁻¹¹. In addition, in H—CuCo, there was a slight shift to lower energy for Co element compared to C—CuCo. This difference may be attributed to variations in the number of neighboring atoms or differences in crystal structures. Cu^{I} and Cu^{II} both existed in the C—CuCo and H—CuCo. However, Cu^{I} was clearly observed in H—CuCo, with a Cu^{I}:Cu^{II} ratio of 1.00:1.50, in contrast to the ratio of 1:14.15 observed in C—CuCo. This suggested that a large amount of Cu^{II} had been reduced to Cu^{I}. Besides, a similar redshift was also displayed in the H—CuCo. Therefore, the unit cell composition of its framework with the negative charges should be [Cu⁺_{0.6}Cu²⁺_{0.9}Co³⁺₁(CN)₆]^{0.6-}. It was noteworthy that protonated dimethylamines (PDs) served as counter-cations, as confirmed by 1H Nuclear Magnetic Resonance (NMR) (FIG. 4A) and thermogravimetric analysis (TGA) results (FIG. 4B).

To further determine the positions of PDs, Rietveld refinement against PXRD data was employed. Derived from the initial structural model of CuCo-prism solved from cRED data, the final Rietveld refinement yielded a converged Rwp of 1.86% and a goodness of fit (GOF) of 2.2. This indicated that 2.4 PDs per unit cell were distributed within the 12-ring channels, balancing the negative charges from the framework.

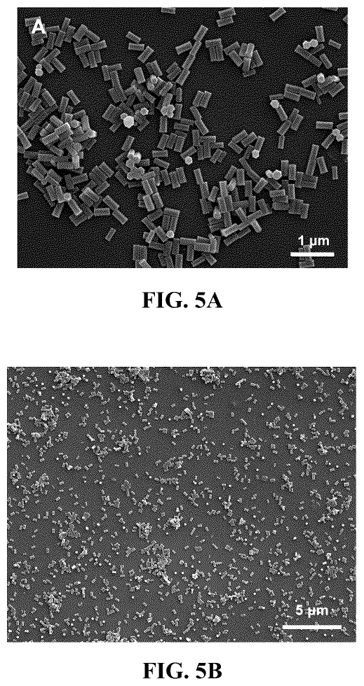

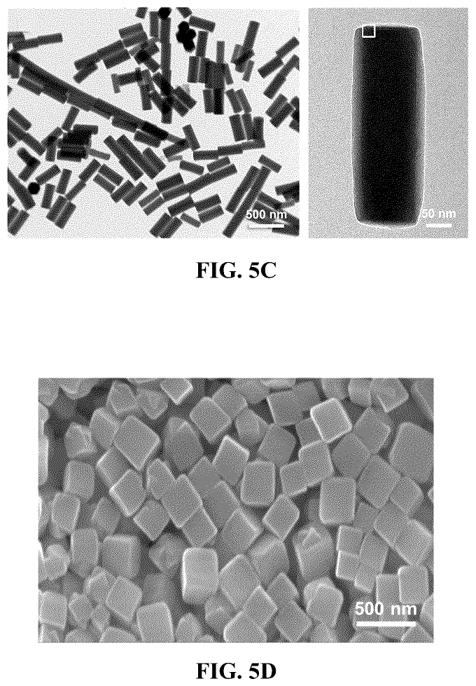

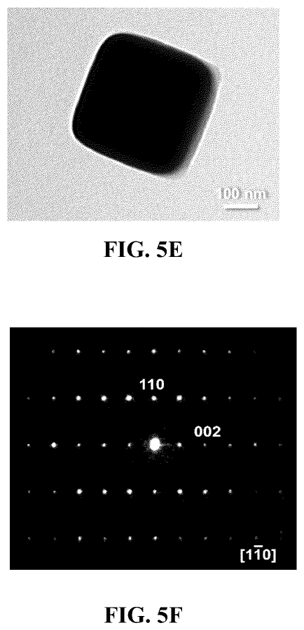

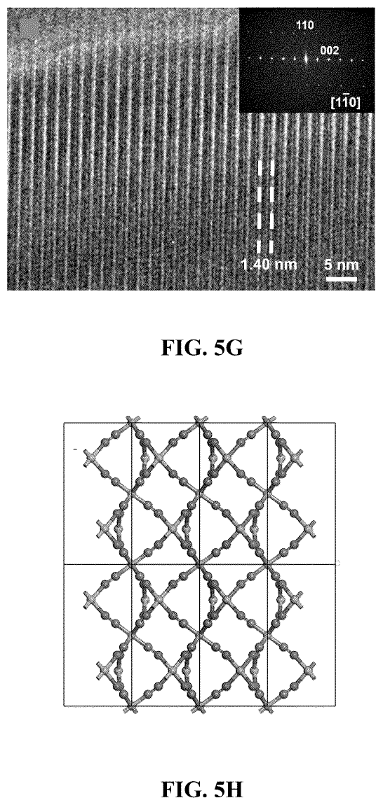

As shown in FIGS. 5A-5B, the SEM images revealed the hexagonal prism morphology of the H—CuCo. Turning to FIG. 5C, the TEM images of H—CuCo also showed the hexagonal prism morphology and reveals the size of the prism was around 125 nm*400 nm. For comparison, the SEM (FIG. 5D) and TEM (FIG. 5E) images of the traditional cubic CuCo PBA displayed the cube morphology with a size of around 180 nm*180 nm.

Referring to FIG. 5F, the corresponding selected area electron diffraction (SAED) pattern along the [1-10] zone axis was displayed. This pattern was fitted to the hexagonal phase instead of the conventional face-centered cubic (fcc) phase of PBA. The high-resolution transmission electron microscopy (HRTEM) image in FIG. 5G was captured from the white square marked in FIG. 5C. It showed lattice fringes with a spacing of approximately 1.40 nm.

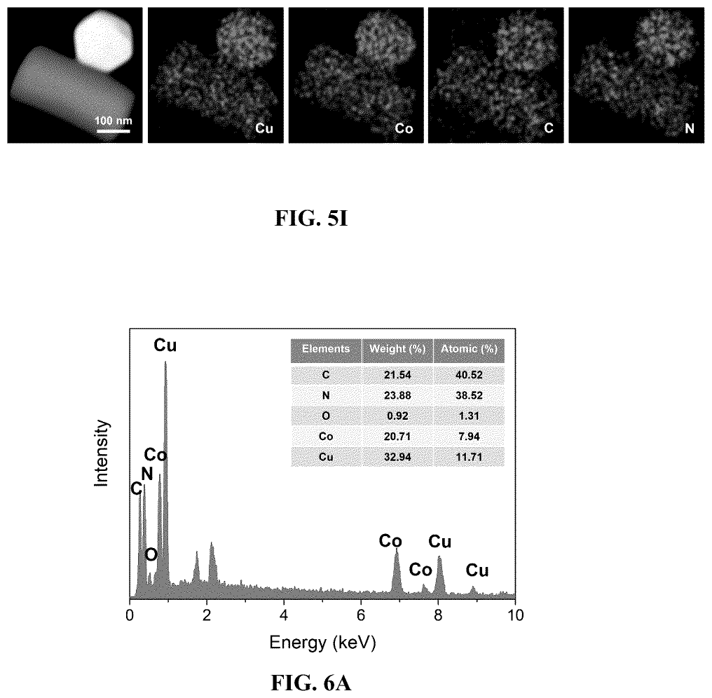

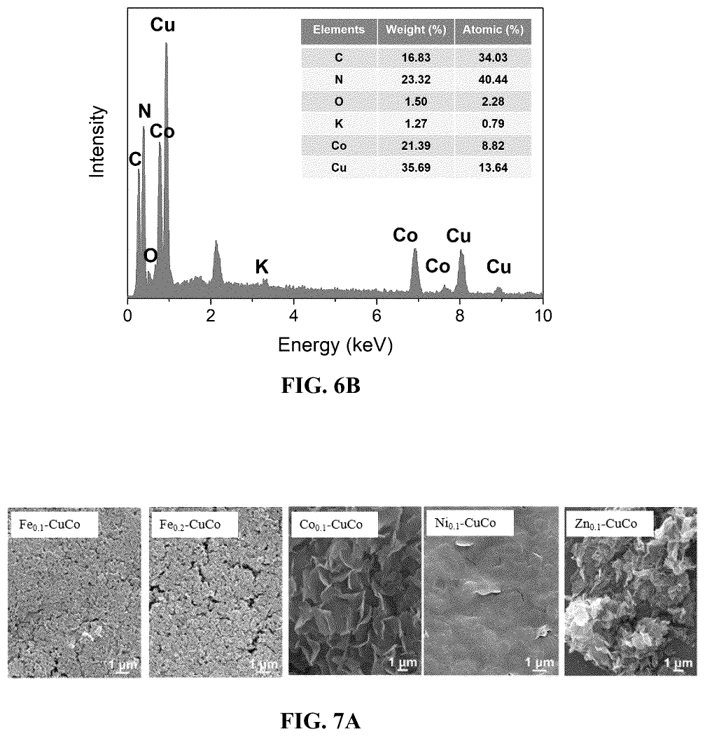

FIG. 5H showed the side view of the lattice of H—CuCo of the [110]. By the high-angle annular dark-field scanning transmission electron microscopy (HAADF-STEM) elemental mapping images (FIG. 5I), the equal distribution of the elements of Cu, Co, C, N were observable for the H—CuCo. The similar chemical composition of Cu, Co, C, N of H—CuCo and C—CuCo were confirmed by the energy-dispersive X-ray spectroscopy (EDS), as shown in FIGS. 6A-6B.

### Example 5—Extended Synthesis

To expand the novel hexagonal phase CuCo PBA, Co, Fe, Ni, and Zn were doped into the synthesis (denote as Co_{0.1}—CuCo, Fe_{0.1}—CuCo, Fe_{0.2}—CuCo, Ni_{0.1}—CuCo, and Zn_{0.1}—CuCo

### Synthesis of Hexagonal Phase Co_{0.1}—CuCo PBAs

5 mL of DI water contained 0.2 mmol of CuCl₂·2H₂0, 0.02 mmol of CoC₂·6H₂O and 0.2 mmol of sodium citrate was added into the mixed solution of 5 ml DI water and 25 ml DMF which dissolved 0.2 mmol of K₃Co(CN)₆ and 0.2 g of PVP. Then, above solution was continuously stirred for 48 h in the 30° C. water bath. After the reaction completed, the precipitate was collected by centrifugation and rinsed with DI water and ethanol 3 times, respectively. Finally, the collected sample was dried at 80° C. in the oven for 12 h.

### Synthesis of Hexagonal Phase Fe_{0.1}—CuCo PBAs

5 mL of DI water contained 0.2 mmol of CuCl₂·2H₂0, 0.02 mmol of FeCl₃·6H₂O and 0.2 mmol of sodium citrate was added into the mixed solution of 5 ml DI water and 25 ml DMF which dissolved 0.2 mmol of K₃Co(CN)₆ and 0.2 g of PVP. Then, above solution was continuously stirred for 48 h in the 30° C. water bath. After the reaction completed, the precipitate was collected by centrifugation and rinsed with DI water and ethanol 3 times, respectively. Finally, the collected sample was dried at 80° C. in the oven for 12 h.

### Synthesis of Hexagonal Phase Fe_{0.2}—CuCo PBAs

5 mL of DI water contained 0.2 mmol of CuCl₂·2H₂0, 0.04 mmol of FeCl₃·6H₂O and 0.2 mmol of sodium citrate was added into the mixed solution of 5 ml DI water and 25 ml DMF which dissolved 0.2 mmol of K₃Co(CN)₆ and 0.2 g of PVP. Then, above solution was continuously stirred for 48 h in the 30° C. water bath. After the reaction completed, the precipitate was collected by centrifugation and rinsed with DI water and ethanol 3 times, respectively. Finally, the collected sample was dried at 80° C. in the oven for 12 h.

### Synthesis of Hexagonal Phase Ni_{0.1}—CuCo PBAs

5 mL of DI water contained 0.2 mmol of CuCl₂·2H₂0, 0.04 mmol of NiCl₂·6H₂O and 0.2 mmol of sodium citrate was added into the mixed solution of 5 ml DI water and 25 ml DMF which dissolved 0.2 mmol of K₃Co(CN)₆ and 0.2 g of PVP. Then, above solution was continuously stirred for 48 h in the 30° C. water bath. After the reaction completed, the precipitate was collected by centrifugation and rinsed with DI water and ethanol 3 times, respectively. Finally, the collected sample was dried at 80° C. in the oven for 12 h.

### Synthesis of Hexagonal Phase Zn_{0.1}—CuCo PBAs

5 mL of DI water contained 0.2 mmol of CuCl₂·2H₂0, 0.02 mmol of ZnCl₂, and 0.2 mmol of sodium citrate were added into the mixed solution of 5 ml DI water and 25 ml DMF which dissolved 0.2 mmol of K₃Co(CN)₆ and 0.2 g of PVP. Then, above solution was continuously stirred for 48 h in the 30° C. water bath. After the reaction completed, the precipitate was collected by centrifugation and rinsed with DI water and ethanol 3 times, respectively. Finally, the collected sample was dried at 80° C. in the oven for 12 h.

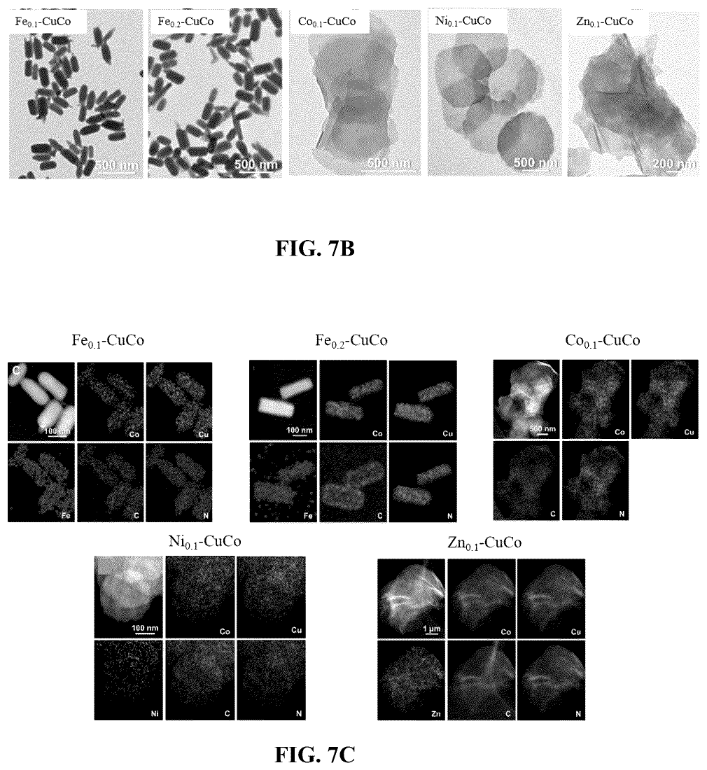

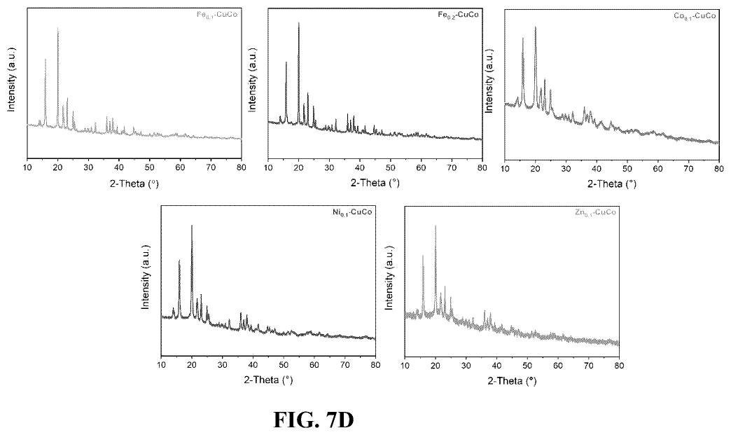

As shown in FIGS. 7A-7D, after doping different transition metal elements with other synthesis conditions constantly, the morphologies of the hexagonal phase PBA transformed from the hexagonal prism to sheet and column. A series of high-angle annular dark-field scanning transmission electron microscopy (HAADF-STEM) images and corresponding elemental mappings indicated that dopant atoms were successfully introduced into the CuCo PBA. This suggested that dopant atoms could significantly impact the morphology. Although the morphology changed dramatically, their XRD patterns indicated that the doped materials still retained the hexagonal phase.

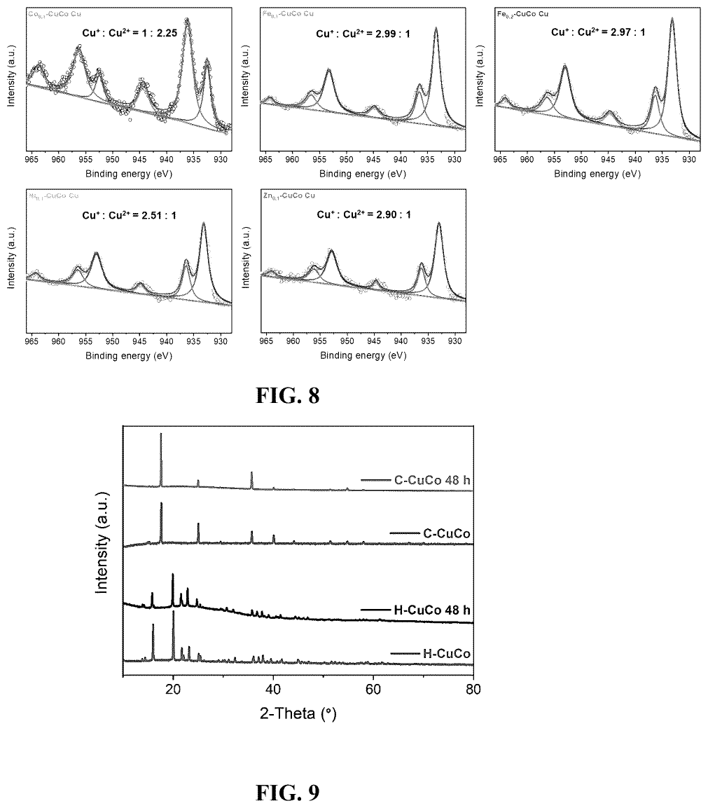

To further investigate the effect of dopant atoms, the XPS test for Cu element of these 5 doped materials was performed (FIG. 8). The XPS spectrums revealed that the ratio of Cu^{I}:Cu^{II} were different, which the ratio of Cu^{I} in Fe_{0.1}—CuCo, Fe_{0.2}—CUCO, Ni_{0.1}—CuCo, and Zn_{0.1}—CuCo were increased a lot compared with H—CuCo. While the ratio of Cu^{I} was declining in Co-_{0.1}CuCo. This indicated that the amount of unsaturated Cu atoms could be modulated by introducing different dopant metallic atoms.

In addition, it was found that the dopant atom could impact the amount of unsaturated copper in the hexagonal phase CuCo PBA. For example, Ni, Fe, and Zn increased the content of Cu^{I}, while doping with Co reduced the amount of Cu^{I}. Thus, based on the XPS results and inductively coupled plasma (ICP) results of the ratio of Cu:Co (Table 4), it was concluded that the formulas of the dopant CuCo PBAs should be [Co²⁺_{0.16}Cu⁺_{0.41}Cu²⁺_{0.93}Co³⁺_{0.84}(CN)₆]^{0.89-}, [F³⁺_{0.02}Cu⁺_{1.32}Cu²⁺_{0.44}+Co³⁺₁(CN)₆]^{0.74-}, [Fe³⁺_{0.03}Cu⁺_{1.25}Cu²⁺_{0.42}Co³⁺₁(CN)₆]^{0.82-}, and [Ni²⁺_{0.06}Cu⁺_{1.12}Cu²⁺_{0.48}Co³⁺₁(CN)₆]^{0.8-}, [Zn²⁺_{0.21}Cu⁺_{1.09}Cu²⁺_{0.38}Co³⁺₁(CN)₆]^{0.73-} respectively, for Co_{0.1}—CuCo, Fe_{0.1}—CuCo, Fe_{0.2}—CuCo, Ni_{0.1}—CuCo, and Zn_{0.1}—CuCo.

Table 4—Atom Ratio of Cu:Co which based on the ICP result for H—CuCo, Co_{0.1}—CuCo, Fe_{0.1}—CuCo, Fe_{0.2}—CuCo, Ni_{0.1}—CuCo, and Zn_{0.1}—CuCo.

| Material | Cu | Co |
|---|---|---|
| C—CuCo | 1.40 | 1 |
| H—CuCo | 1.50 | 1 |
| Co_{0.1}—CuCo | 1.34 | 1 |
| Ni_{0.1}—CuCo | 1.57 | 1 |
| Fe_{0.1}—CuCo | 1.76 | 1 |
| Fe_{0.2}—CuCo | 1.67 | 1 |
| Zn_{0.1}—CuCo | 1.47 | 1 |

### Example 6—Gas Uptake and Separation Performance

To confirm the permanent porosity after solvent removal, Brunauer-Emmett-Teller (BET) nitrogen gas adsorption experiments were conducted at 77 K. Brunauer-Emmett-Teller (BET) nitrogen gas adsorption experiments are a common experimental method used for surface area measurement and pore structure analysis. This technique involves the adsorption of nitrogen gas onto the surface of a material at various pressures to determine its specific surface area and pore structure. By measuring the amount of nitrogen adsorbed on the material surface as a function of adsorption pressure, parameters such as specific surface area, pore volume, and pore size distribution can be calculated, providing valuable insights into the material's pore structure characteristics.

Before the BET test, H—CuCo and C—CuCo were treated at 100° C. in vacuum, and the XRD patterns before and after treatment were collected. Referring to FIG. 9, the XRD patterns of C—CuCo before and after treatment were nearly identical. However, a peak at 17.6° disappeared for H—CuCo after the drying treatment. This should be due to the gas degassing. Additionally, it was observed that the color of H—CuCo was purple when it was removed from the vacuum, but turned blue upon exposure to air, indicating the stable structure of H—CuCo.

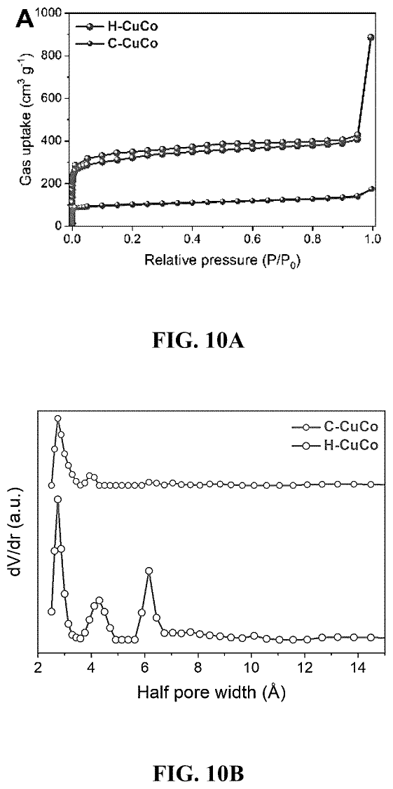

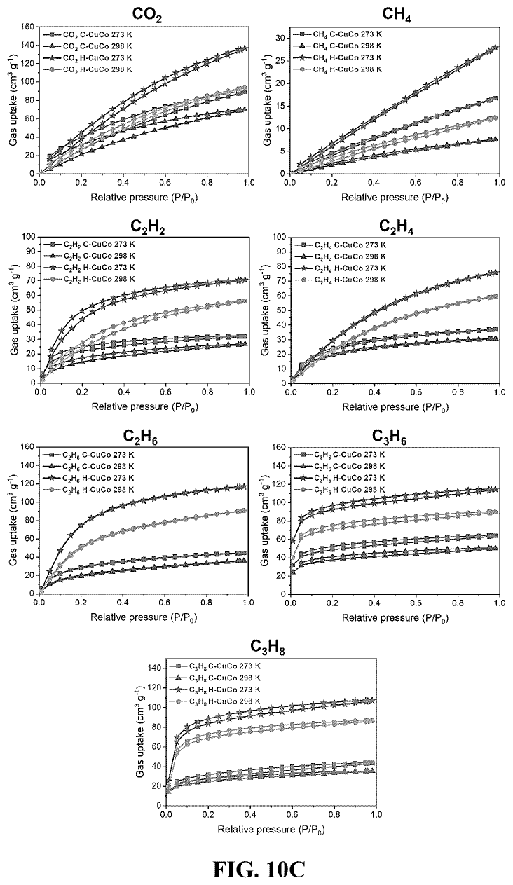

FIG. 10A of BET showed the surface area calculated via DFT calculation of 1273.244 m² g⁻¹ of H—CuCo, in contrast to the surface area of 443.416 m² g⁻¹. Compared to other conventional PBAs, the surface area of H—CuCo was significantly higher, exceeding 900 m² g⁻¹, whereas the reported surface area of other PBAs was lower than 900 m² g⁻¹. Additionally, FIG. 10B illustrated that H—CuCo had three types of pores, with half pore widths of 2.74, 4.30, and 6.16 Å, contributing to a total pore volume of 0.800 cm³ g⁻¹. This contrasted with C—CuCo, which had only one type of pores with a half pore width and pore volume of 0.217 cm³ g⁻¹.

In the following, the sorption isotherms of single-component gases (CO₂, CH₄, C₂H₂, C₂H₄, C₂H, C₃H₆, and C₃H₈) of H—CuCo and C—CuCo PBAs were carried out at 273 to 298 K (FIG. 10C, and Table 1).

TABLE 1
Gas sorption performance of H—CuCo, C—CuCo, Fe_{0.1}—CuCo, Fe_{0.2}—CuCo and Co_{0.1}—CuCo.

| | surface | CO₂ | CH₄ | C₂H₂ | C₂H₄ | C₂H₆ | C₃H₆ | C₃H₈ |
|---|---|---|---|---|---|---|---|---|
| | area | adsorption | adsorption | adsorption | adsorption | adsorption | adsorption | adsorption |
| Material | (m² g⁻¹) | (cm³ g⁻¹) | (cm³ g⁻¹) | (cm³ g⁻¹) | (cm³ g⁻¹) | (cm³ g⁻¹) | (cm³ g⁻¹) | (cm³ g⁻¹) |
| H—CuCo | 1273 | 136.7 | 28.0 | 70.6 | 76.0 | 116.9 | 114.9 | 107.3 |
| | | (273K) | (273K) | (273K) | (273K) | (273K) | (273K) | (273K) |
| | | 93.7 | 12.5 | 56.3 | 59.6 | 90.9 | 90.1 | 86.9 |
| | | (298K) | (298K) | (298K) | (298K) | (298K) | (298K) | (298K) |
| C—CuCo | 443 | 89.6 | 16.7 | 32.3 | 36.9 | 44.5 | 64.2 | 43.8 |
| | | (273K) | (273K) | (273K) | (273K) | (273K) | (273K) | (273K) |
| | | 69.6 | 7.6 | 26.7 | 30.8 | 36.1 | 50.6 | 35.5 |
| | | (298K) | (298K) | (298K) | (298K) | (298K) | (298K) | (298K) |
| Fe_{0.1}—CuCo | 969 | 107.4 | 23.3 | 139.1 | 114.0 | 91.7 | 125.9 | 99.1 |
| | | (273K) | (273K) | (273K) | (273K) | (273K) | (273K) | (273K) |
| | | 68.6 | 11.5 | 101.6 | 83.1 | 77.6 | 96.0 | 87.7 |
| | | (298K) | (298K) | (298K) | (298K) | (298K) | (298K) | (298K) |
| Fe_{0.2}—CuCo | 799 | 95.8 | 20.3 | 110.3 | 102.4 | 82.9 | 105.5 | 91.7 |
| | | (273K) | (273K) | (273K) | (273K) | (273K) | (273K) | (273K) |
| | | 62.0 | 10.1 | 83.7 | 66.0 | 70.7 | 74.9 | 80.0 |
| | | (298K) | (298K) | (298K) | (298K) | (298K) | (298K) | (298K) |
| Co_{0.1}—CuCo | 937 | 91.0 | 21.0 | 118.3 | 106.9 | 79.4 | 114.4 | 86.8 |
| | | (273K) | (273K) | (273K) | (273K) | (273K) | (273K) | (273K) |
| | | 66.4 | 10.6 | 90.1 | 75.0 | 66.6 | 81.9 | 74.0 |
| | | (298K) | (298K) | (298K) | (298K) | (298K) | (298K) | (298K) |

In particular, H—CuCo exhibited a gravimetric C₂ uptake of 136.41 cm³ g⁻¹ (6.09 mmol g⁻¹) at 273 K, 1 bar, indicating that 8.2 CO₂ molecules were captured by 1H—CuCo. For 298 K and 1 bar, the CO₂ uptake of H—CuCo was 93.65 cm³g⁻¹ (4.18 mmol g⁻¹). Both of these CO₂ uptakes exceeded the values of 89.57 and 69.87 cm³ g⁻¹ (4.00 and 3.12 mmol g⁻¹) for C—CuCo at 273 K and 298 K, respectively, at 1 bar.

For CH₄, C₂H₂, C₂H₄, C₂H₆, C₃H₆, and C₃H₈, the H—CuCo also showed better uptake capabilities, more than 1.5 times that of C—CuCo under the same conditions, which indicated the hexagonal phase CuCo PBA processes much better gas uptake capability than the conventional cubic phase of CuCo PBA. Table 2 also demonstrated that the CO₂ adsorption capacity of H—CuCo was among the highest compared to previously reported materials.

TABLE 2
Selected examples for CO₂ storage.

| | | | | |
|---|---|---|---|---|
| | | | CO₂ adsorption | |
| | Surface area^{a} | Temperature | capacity^{b} | |
| Material | (m²/g) | (K) | (mmol/g) | Noted |

CO₂ adsorption performance of PBA materials

| H—CuCo | 1273 | 273 | 6.1 | This |
|---|---|---|---|---|
| | | 298 | 4.2 | work |
| C—CuCo | 443 | 273 | 4.0 | |
| | | 298 | 3.1 | |
| Fe_{0.1}—CuCo | 960 | 273 | 4.8 | |
| Fe_{0.2}—CuCo | 799 | 273 | 4.3 | |
| Co_{0.1}—CuCo | 937 | 273 | 4.1 | |
| K_{2x/3}Cu^{II} [Fe^{II}ₓFe^{III}₁₋ₓ | 504 | 273 | 4.5 | Prior art |
| (CN)₆]_{2/3}•nH₂O (x = 0) | | | | |
| K_{2x/3}Cu^{II} [Fe^{II}ₓFe^{III}₁₋ₓ | 370 | 273 | 3.0 | |
| (CN)₆]_{2/3}•nH₂O (x = 1) | | | | |

| | | | |
|---|---|---|---|
| K_{0.24+y}Ni_{2.88}[Fe^{II}_{y}Fe^{III}_{1-y}(CN)₆]₂•nH₂O | 110 | 273 | 3.0 |

CO₂ adsorption performance of silicate materials

| | | | | |
|---|---|---|---|---|
| Fe-MOR(0.25) | 282 | 273 | 5.7 | Prior art |
| NaTEA-ZSM-25 | — | 298 | 3.5 | |
| Na-Rho | — | 298 | 4.5 | |
| SGU-29 | 457 | 298 | 3.5 | |

CO₂ adsorption performance of COF materials

| | | | | |
|---|---|---|---|---|
| JUC-505 | 1584 | 273 | 5.3 | Prior art |
| 2D sql COF | 3478 | 298 | 1.76 | |
| CoTAPP-PATA-COF | 944 | 273 | 2.1 | |
| RC-COF-1 | 1712 | 273 | 6.6 | |

CO₂ adsorption performance of MOF materials

| SIFSIX-2-Cu-i | 735 | | 298 | 5.4 | Prior art |
|---|---|---|---|---|---|
| SIFSIX-3-Zn | 250 | | 298 | 2.5 | |
| Mg2V-DHBDC | 1475 | (2117^{c}) | 273 | 10.4 | |
| Mn^{II}Mn^{III}(OH)Cl₂(bbta) | 1286^{c} | | 298 | 7.1 | |
| FJI-14H | 904 | (1004^{c}) | 298 | 12.5 | |

| mmen-Mg₂(dobpdc) | 3326 | 298 | 4.1 | |
|---|---|---|---|---|
| CALF-20 | 528^{c} | 293 | 4.1 | (1.2 bar) |
| [(Y_{0.95}Eu_{0.05})(H₃pptd)]•xSolvent | 566 | 195 | 7.3 | (0.3 bar) |
| [K₃(Y_{0.95}Eu_{0.05})(pptd)]•zSolvent | 498 | 195 | 6.7 | (0.3 bar) |
| Im-UiO-PL | — | 298 | 5.9 | (9 bar) |

| ALF | 588 | 273 | 2.7 |
|---|---|---|---|
| Qc-5-Cu-sql-β | 222 | 293 | 2.2 |
| CG-3 | 1470 | 273 | 7.9 |
| CG-9 | 1532 | 273 | 8.3 |
| PN@MOF-5 | 1200 | 273 | 3.5 |
| Tetramethylammonium@bio-MOF-1 | 1460 | 273 | 4.5 |
| LIFM-33 | 1589 | 273 | 3.6 |
| [Mn(bdc)(dpe)] | 535 | 195 | 5.0 |
| {[Zn₂(BME-bdc)₂- | — | 195 | 7.0 |
| (bipy)]ₙ(DMF)_{2.3}(EtOH)_{0.4}} | | | |

| | | | | |
|---|---|---|---|---|
| SHF-61-CHCl₃ | 544^{c} | 298 | 6.3 | (19.5 bar) |

| | | | | |
|---|---|---|---|---|
| CPM-5 | 580 | (733^{c}) | 273 | 3.6 |
| CPM-6 | 596 | (931) | 273 | 4.8 |
| (choline)₃[In₃(btc)₄]•2 DMF | 508 | (712^{c}) | 273 | 3.2 |
| CPM-33a | 966 | (1257^{c}) | 273 | 6.1 |
| CPM-33b | 808 | (1119^{c}) | 273 | 7.8 |

| NOTT-202a | 2220 | 195 | 20.0 | |
|---|---|---|---|---|
| Ni—4PyC | 945 | 298 | 8.2 | (10 bar) |

| [Zn(2)]ₙ (3) | 802 | | 298 | 2.1 |
|---|---|---|---|---|
| CPF-6 | 599 | (883^{c}) | 273 | 4.4 |
| MAF-23 | 622^{c} | | 273 | 3.3 |
| MAF-25 | 511^{c} | | 195 | 5.2 |
| Cu-TDPAT | 1938 | (2608^{c}) | 298 | 5.9 |
| IRMOF-74-III-CH₂NH₂ | 2310 | | 298 | 3.3 |
| IRMOF-74-III-(CH₂NH₂)₂ | — | | 298 | 3.0 |
| CAU-1 | 1268 | | 273 | 7.2 |
| PCN-88 | 3308 | (3845^{c}) | 273 | 7.1 |
| Cu-BTTri (1) | 1770 | (1900^{c}) | 298 | 3.2 |

| | | | |
|---|---|---|---|
| SNU-5 | 2850^{c} | 273 | 1.7 |

^{a}Unless otherwise stated, the surface area is calculated by the Brunauer-Emmett-Teller (BET) methods.
^{b}Unless otherwise stated, the CO₂ adsorption amount measured at 1 bar.
^{c}The surface area is calculated by the Langmuir method.

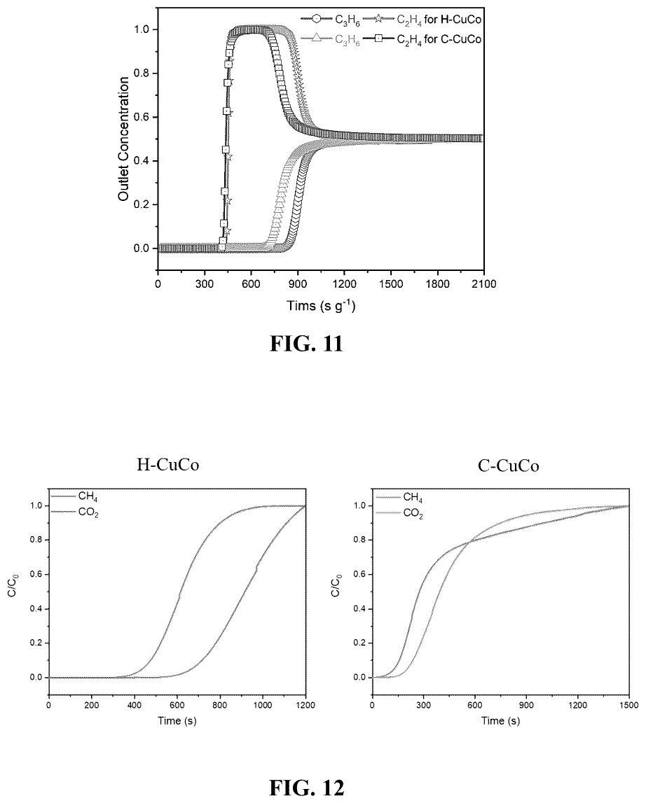

What is more, experimental breakthrough experiments were conducted for C₃H₆/C₂H₄ (50/50, v/v) at 273 K. Referring to FIG. 11, the C₂H₄ breakthrough occurred at 439 s/g for H—CuCo PBAs, while almost the same time for C—CuCo PBAs at 412 s/g. However, the retention time of C₃H₆ in the packed column for H—CuCo was 779 s/g, which was longer than that of C—CuCo, which was 670 s/g. The separation coefficient of C₃H₆ to C₂H₄ for H—CuCo was 6.82, which was twice that of C—CuCo, which was 3.35.

Referring to FIG. 12, unlike C—CuCo, which showed no separating behavior for CO₂/CH₄, H—CuCo exhibited potential CO₂/CH₄ separation behavior, representing a significant breakthrough. These results suggested that phase engineering offered a new and promising strategy for gas capture and separation.

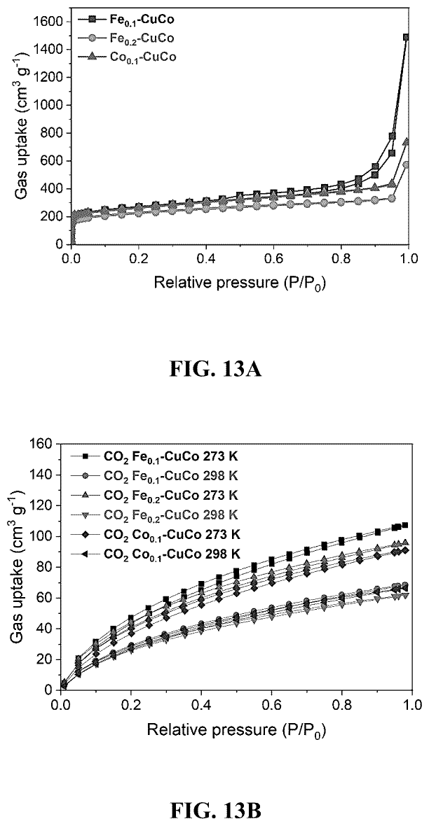

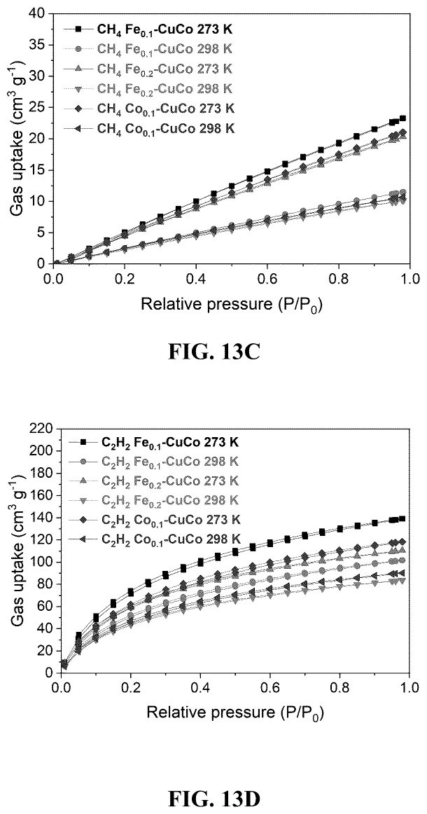

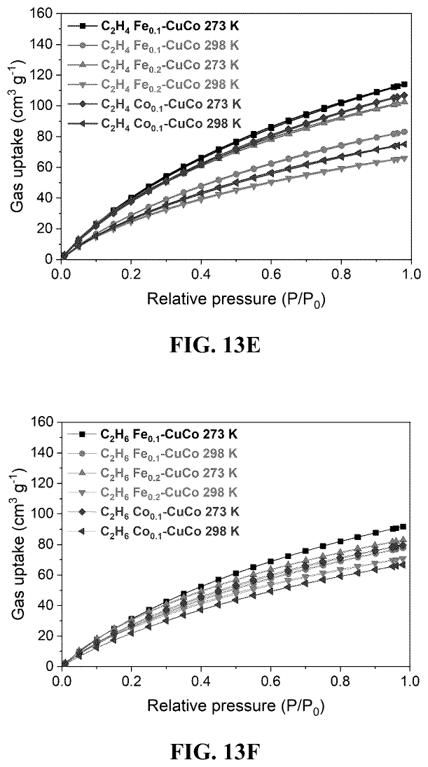

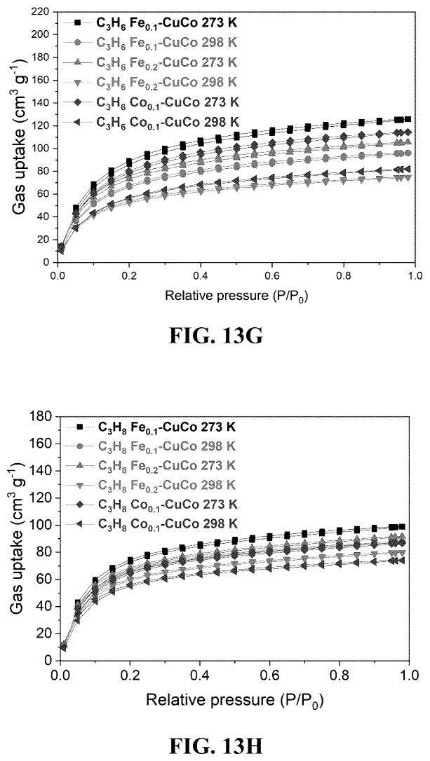

To further explore the gas capture performance of the dopant CuCo PBA, serials of BET and single gas uptake measurements were performed (Table 5 and FIGS. 13A-13H).

TABLE 5
Surface area of PBAs.

| Materials | Surface area (m² g⁻¹) | Note |
|---|---|---|
| H—CuCo | 1273 | This work |
| C—CuCo | 443 | |
| Fe_{0.1}—CuCo | 960 | |
| Fe_{0.2}—CuCo | 799 | |
| Co_{0.1}—CuCo | 937 | |
| CoHCF | 547 | Prior art |
| CoHCC | 848 | |
| Mn₃[Co(CN)₆]₂ | 870 | |
| Fe₃[Co(CN)₆]₂ | 770 | |
| Co₃[Co(CN)₆]₂ | 800 | |
| Ni₃[Co(CN)₆]₂ | 560 | |
| Cu₃[Co(CN)₆]₂ | 730 | |
| Zn₃[Co(CN)₆]₂ | 720 | |
| Ga[Co(CN)₆] | 570 | |
| Fe₄[Fe(CN)₆]₃ | 550 | |
| Cu₃[Co(CN)₆]₂ | 750 | |
| Co₂[Fe(CN)₆] | 370 | |
| Ni₂[Fe(CN)₆] | 460 | |
| Cu₂[Fe(CN)₆] | 730 | |
| Co₃[Co(CN)₅]₂ | 730 | |
| Cu^{III}₃[Co^{II}(CN)₆]₂ | 793 | |
| Mn^{III}₃[Co^{II}(CN)₆]₂ | 783 | |
| Ni^{III}₃[Co^{II}(CN)₆]₂ | 529 | |
| Co^{III}₃[Co^{II}(CN)₆]₂ | 712 | |
| Zn^{III}₃[Co^{II}(CN)₆]₂ | 700 | |
| K_{1.04+y}Ni_{2.48}[Fe^{II}_{y}Fe^{III}_{1-y}(CN)₆]₂ □ nH₂O | 72 | |
| K_{0.24+y}Ni_{2.88}[Fe^{II}_{y}Fe^{III}_{1-y}(CN)₆]₂ □ nH₂O | 110 | |
| K_{2x/3}Cu^{II} [Fe^{II}ₓFe^{III}₁₋ₓ (CN)₆]_{2/3}•nH₂O | 504 | |
| (x = 0) | | |
| K_{2x/3}Cu^{II} [Fe^{II}ₓFe^{III}₁₋ₓ (CN)₆]_{2/3}•nH₂O | 370 | |
| (x = 1) | | |
| [Co₃Fe₂] | 448 | |
| [Ni₃Fe₂] | 541 | |
| [Cu₃Fe₂] | 422 | |
| [Mn₃Fe₂] | 704 | |
| [Fe₃Fe₂] | 677 | |
| [Co₃Co₂] | 678 | |
| [Ni₃Co₂] | 670 | |
| [Cu₃Co₂] | 689 | |
| [Mn₃Co₂] | 869 | |
| [Fe₃Co₂] | 779 | |
| Li₂Zn₃[Fe(CN)₆]₂•2H₂O | 250 | |
| Na₂Zn₃[Fe(CN)₆]₂ | 570 | |
| K₂Zn₃[Fe(CN)₆]₂ | 470 | |
| Rb₂Zn₃[Fe(CN)₆]₂ | 430 | |
| Zn₃[Co(CN)₆]₂ | 720 | |

Compared to Co_{0.1}—CuCo, Fe_{0.1}—CuCo exhibited a higher specific surface area and better gas capture performance. This suggested that unsaturated active atoms enhanced the storage of small molecular gases. Furthermore, the results showed that doping CuCo PBA significantly increased gas uptake performance, such as for C₂H₄ and C₂H₆. However, excessively high doping rates led to lower specific surface area and gas uptake performance.

### Example 7—Mechanism

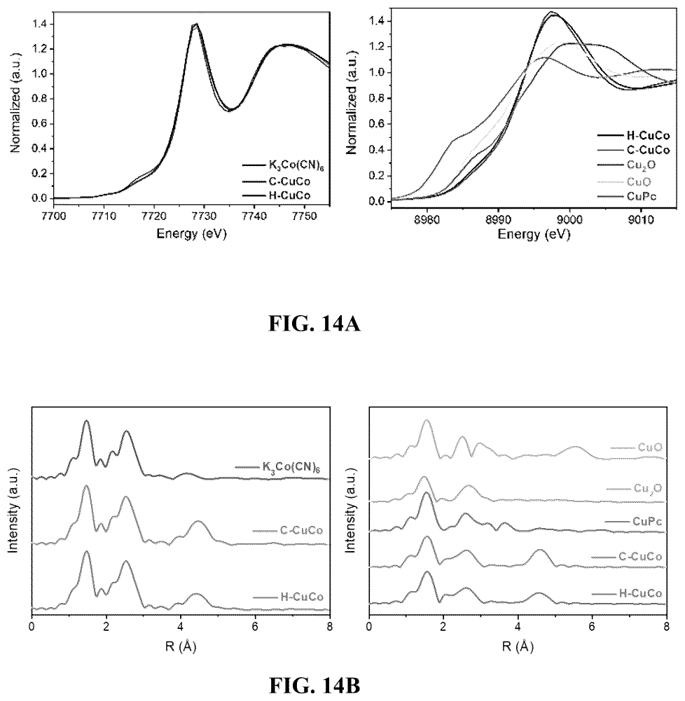

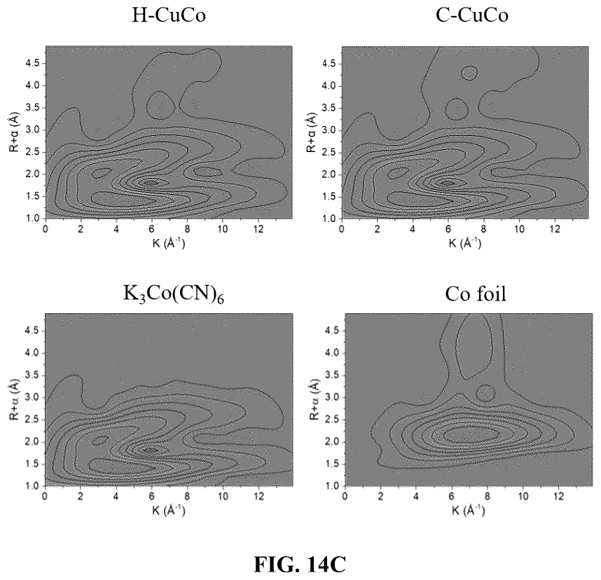

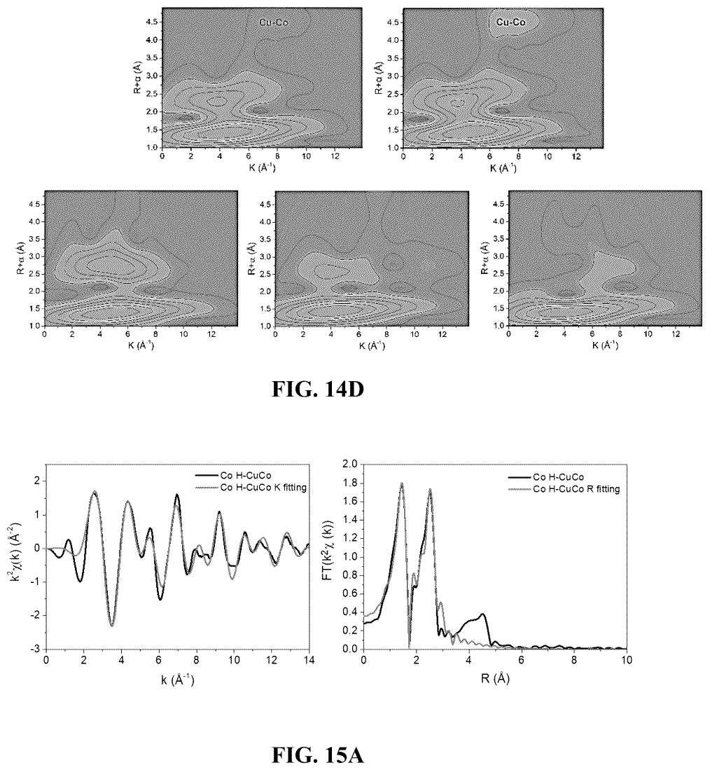

To study the reason for enhancing performance of H—CuCo, the XAFS measurements were performed to evaluate the local electronic and geometric structures of the metal elements in the as-prepared H—CuCo. The K-edge X-ray absorption near edge structure (XANES) for the Co element of H—CuCo, C—CuCo, and K₃Co(CN)₆ was shown in FIG. 14A. The similar curves of the XANES pattern for Co further confirmed that H—CuCo belongs to the PBA family. Besides, the well-overlapped pre-edge XANES pattern of Co displayed that the Co element in the H—CuCo, C—CuCo, and K₃Co(CN)₆ had the same valence and circumstances of Co—C—N.

In the corresponding Fourier transform X-ray absorption fine structure (FT-EXAFS) of K-edge for Co (FIG. 14B), the peaks located at 1.47, 2.55, and 4.45 Å in R space should be denoted as attributed to Co—C, Co—C—N, and Co—C≡N—Cu scattering respectively.

In addition, based on the intensity of wavelet transforms (WT) of EXAFS (FIG. 14C) for Co—C and Co—C—N, it is suggested that H—CuCo, C—CuCo and K₃Co(CN)₆ have the same coordination number for Co—C and Co—C—N. However, the intensity of Co—C—N—Cu of H—CuCo in WT and FT-EXAFS was obviously lower than the C—CoCu that in C—CuCo for Co element, meaning the lower coordination number of Co—C—N—Cu in H—CuCo.

Besides, the Cu K-edge XANES of H—CuCo, C—CuCo, Cu₂O, CuO, and CuPc were tested. The highly similar absorption energies and the white-line peak profiles of H—CuCo and C—CuCo in the XANES proved the PBAs family's feature once again, while they are quite different from the features of CuPc, CuO and Cu₂O references due to the diverse atom environments of Cu—N≡C for PBAs. The pre-edge absorption energy of H—CuCo slightly shifted to lower energy, indicating a lower valence of Cu in H—CuCo. Besides, based on the pre-edge curve of CuPc, the slightly higher pre-edge peak at around 8987 eV of H—CuCo suggested more plane quadrilateral configuration than C—CuCo for Cu element.

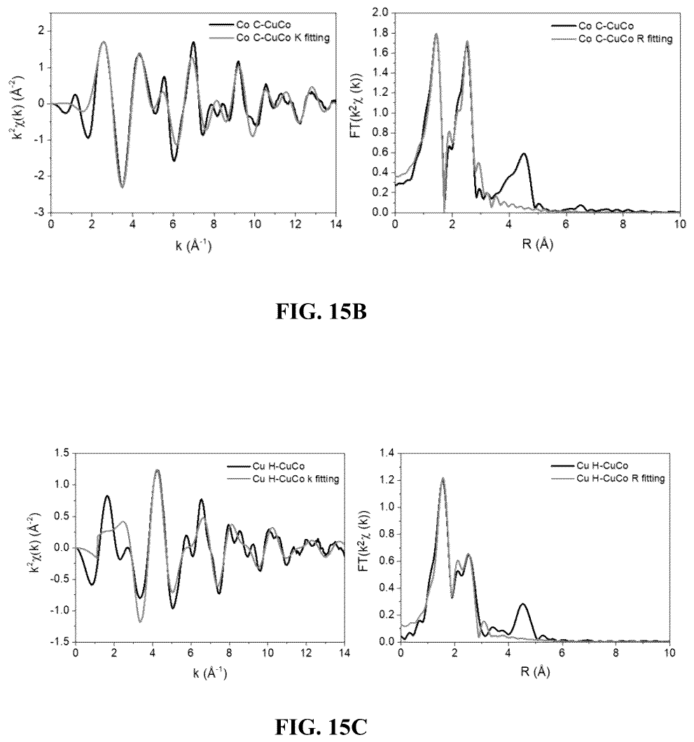

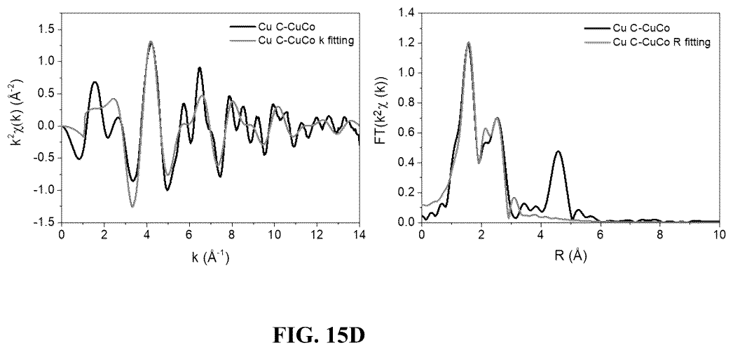

In the FT-EXAFS of Cu, the peaks located at 1.56 and 2.60 Ain R space should be assigned to Cu—N and Cu—N≡C scattering, which was similar to CuPc. The intensities of Cu—N for H—CuCo and C—CuCo were the same, while the intensity of Cu—NC for H—CuCo was slightly lower than C—CuCo, that was because of more planar configuration for Cu atoms. For peaks at 4.60 Å, it should be denoted as the Cu—N═C—Co, and the Cu—N═C—Co bonds also showed a similar situation of obviously lower intensity in H—CuCo, which consisted of the FT-EXAFS of Co. These features were also confirmed by wavelet transforms (FIG. 14). Then, after performing fitting and calculating via FT-EXAFS of Co and Cu (FIGS. 15A-15D), detailed coordination numbers of H—CuCo and C—CuCo were listed in Table 3.

TABLE 3
EXAFS fitting results.

| Sample | Path | CN | σ² | ΔE₀ | R | R-factor |
|---|---|---|---|---|---|---|
| CuCo | Cu—N | 4.3(0.5) | 0.0036(0.0012) | 4.84(1.14) | 1.98(0.01) | 0.019 |
| Prism | Cu—C | 4.3(0.5) | 0.0038(0.0013) | 4.84(1.14) | 3.15(0.01) | |
| | Co—C | 6.3(0.5) | 0.0023(0.0008) | 0.04(0.88) | 1.89(0.01) | |
| | Co—N | 6.3(0.5) | 0.0013(0.0005) | 0.04(0.88) | 3.06(0.01) | |
| CuCo | Cu—N | 4.8(0.5) | 0.0048(0.0013) | 4.60(1.11) | 2.00(0.01) | 0.019 |
| Cube | Cu—C | 4.8(0.5) | 0.0039(0.0015) | 4.60(1.11) | 3.17(0.01) | |
| | Co—C | 6.3(0.5) | 0.0024(0.0007) | 0.00(0.87) | 1.89(0.01) | |
| | Co—N | 6.3(0.5) | 0.0014(0.0006) | 0.00(0.87) | 3.06(0.01) | |

The results indicated that the coordination numbers of Co—C and Co—C≡N were the same for H—CuCo and C—CuCo. However, the coordination numbers of Cu—N and Cu—N≡C in H—CuCo were lower than those in C—CuCo due to the presence of some unsaturated Cu forming a planar configuration, which was consistent with the above analysis.

The presence of opened metal sites could have contributed to both uptake capacity and separation selectivity. Therefore, it was considered that the superior gas uptake and separation performance not only arose from the higher specific surface area but also from the abundance of planar configurations of Cu—N—C, which provided opened and unsaturated Cu atoms with low valence to coordinate with gas molecules. This beneficial effect was attributed to the novel hexagonal phase of H—CuCo.

### INDUSTRIAL APPLICABILITY

The hexagonal phase H—CuCo PBAs and their doping derivatives find extensive application in various fields due to their unique properties, such as gas storage and separation, electrochemical biosensors, photothermal therapy, catalysis, nanozymes, drug delivery systems, removal of radioactive ions, energy storage devices and water desalination technologies.

### Definitions

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

“Cu^{I}” and “Cu^{II}” refer to different oxidation states of copper. “Cu^{I}” represents the +1 oxidation state of copper (copper(I) or cuprous), while “Cu^{II}” represents the +2 oxidation state (copper(II) or cupric).

Other definitions for selected terms used herein may be found within the detailed description of the present invention and apply throughout. Unless otherwise defined, all other technical terms used herein have the same meaning as commonly understood to one of ordinary skill in the art to which the present invention belongs.

### REFERENCE

1. Pal, S. C., Krishna, R., & Das, M. C. (2023). Highly scalable acid-base resistant Cu-Prussian blue metal-organic framework for C2H2/C2H4, biogas, and flue gas separations. Chemical Engineering Journal, 460, 141795.
2. Zhang, D.; Oleynikov, P.; Hovmöller, S.; Zou, X., Collecting 3D electron diffraction data by the rotation method. Z. Kristallogr. 2010, 225 (2-3), 94-102.
3. Shi, D.; Nannenga, B. L.; Iadanza, M. G.; Gonen, T., Three-dimensional electron crystallography of protein microcrystals. Elife 2013, 2, e01345.
4. Nannenga, B. L.; Shi, D.; Leslie, A. G. W.; Gonen, T., High-resolution structure determination by continuous-rotation data collection in MicroED. Nat. Methods 2014, 11 (9), 927-930.
5. Kolb, U.; Gorelik, T.; Kubel, C.; Otten, M. T.; Hubert, D., Towards automated diffraction tomography: part I—data acquisition. Ultramicroscopy 2007, 107(6-7), 507-13.
6. Wan, W.; Sun, J.; Su, J.; Hovmoller, S.; Zou, X., Three-dimensional rotation electron diffraction: software RED for automated data collection and data processing. J. Appl. Crystallogr. 2013, 46 (Pt 6), 1863-1873.
7. Cichocka, M. O.; Ångström, J.; Wang, B.; Zou, X.; Smeets, S., High-throughput continuous rotation electron diffraction data acquisition via software automation. J. Appl. Crystallogr. 2018, 51 (Pt 6), 1652-1661.
S. Wang, Y.; Takki, S.; Cheung, O.; Xu, H.; Wan, W.; Ohrstrom, L.; Inge, A. K., Elucidation of the elusive structure and formula of the active pharmaceutical ingredient bismuth subgallate by continuous rotation electron diffraction. Chem. Commun. 2017, 53 (52), 7018-7021.
9. Sheldrick, G. M., SHELXT—integrated space-group and crystal-structure determination. Acta Crystallogr. A 2015, 71 (1), 3-8.
10. Oku, M.; Hirokawa, K., X-ray photoelectron spectroscopy of Co3O4, Fe3O4, Mn3O4, and related compounds. J. Electron Spectrosc. Relat. Phenom. 1976, 8 (5), 475-481.
11. Oku, M.; Hirokawa, K.; Ikeda, S., Photoelectron spectral intensities of some first transition series elements in metal cyanides containing inequivalent atoms. J. Electron Spectrosc. Relat. Phenom. 1975, 6 (5), 451-458.

What is claimed is:

1. A hexagonal phase copper-cobalt Prussian blue analog material, comprising:
30-40 wt % of copper;
10-30 wt % of cobalt;
10-30 wt % of carbon; and
10-30 wt % of nitrogen,
wherein each copper ion is coordinated with four cyanogen groups showing a plane quadrilateral configuration, while each copper ion is connected with six cyanogen groups showing an octahedral configuration.

2. The hexagonal phase copper-cobalt Prussian blue analog material of claim 1, wherein the hexagonal phase copper-cobalt Prussian blue analog material is capable of forming prism-shaped crystals.

3. The hexagonal phase copper-cobalt Prussian blue analog material of claim 1, wherein the hexagonal phase copper-cobalt Prussian blue analog material has a 20 value of 13.9°, 14.4°, 16.0°, 20.1°, 21.7°, 22.1°, 23.2°, 25.1°, 25.5°, 26.2°, 29.1°, 29.9°, 31.1°, 32.4°, 36.1°, 37.1°, 37.9°, 38.8°, 39.5°, 40.8°, 41.7°, 44.9°, 45.8°, 46.2°, 47.1°, 50.2°, 51.6°, 52.4°, 53.2°, 53.9°, 55.3°, 57.5°, 57.8°, 58.9°, 61.2°, 61.7°, 62.9°, 64.0°.

4. The hexagonal phase copper-cobalt Prussian blue analog material of claim 1, wherein the hexagonal phase copper-cobalt Prussian blue analog material exhibits stacking disorders in a hexagonal lattice structure.

5. The hexagonal phase copper-cobalt Prussian blue analog material of claim 1, wherein the hexagonal phase copper-cobalt Prussian blue analog material has a surface area of at least 1000 m² g⁻¹.

6. The hexagonal phase copper-cobalt Prussian blue analog material of claim 1, wherein the hexagonal phase copper-cobalt Prussian blue analog material has larger channels and interstitial spaces for metal-ion storage and diffusion.

7. The hexagonal phase copper-cobalt Prussian blue analog material of claim 1, wherein the hexagonal phase copper-cobalt Prussian blue analog material exhibits three types of pores with half pore widths of 2.74, 4.30, and 6.16 Å.

8. The hexagonal phase copper-cobalt Prussian blue analog material of claim 1, wherein numerous unsaturated copper sites are present within a framework of hexagonal phase copper-cobalt.

9. The hexagonal phase copper-cobalt Prussian blue analog material of claim 8, wherein numerous Cu^{I} and a low coordination number of Cu—N≡C—Co are presented in hexagonal phase copper-cobalt Prussian blue analog material.

10. The hexagonal phase copper-cobalt Prussian blue analog material of claim 1, wherein the hexagonal phase copper-cobalt Prussian blue analog material demonstrates a gas adsorption performance that is at least 1.5 times higher than that of cubic PBAs.

11. The hexagonal phase copper-cobalt Prussian blue analog material of claim 10, wherein the gas comprises CO₂, CH₄, C₂H₂, C₂H₄, C₂H₆, C₃H₆, and C₃H₈.

12. The hexagonal phase copper-cobalt Prussian blue analog material of claim 1, wherein the hexagonal phase copper-cobalt Prussian blue analog material demonstrates superior separation performance for C₃H₆/C₂H₄ and CO₂/CH₄ compared to a cubic Prussian blue analog material.

13. The hexagonal phase copper-cobalt Prussian blue analog material of claim 1, wherein the hexagonal phase copper-cobalt Prussian blue analog material is further doped with one or more metal precursors.

14. The hexagonal phase copper-cobalt Prussian blue analog material of claim 13, wherein the one or more metal precursors comprise FeCl₃, NiCl₂, or ZnCl₂, or their hydrates.

15. A method for synthesizing hexagonal phase copper-cobalt Prussian blue analog material, comprising:
adding DI water containing CuCI₂·2H₂O, and sodium citrate into a mixed solution of DI water and DMF dissolved K₃Co(CN)₆ and PVP to obtain a first solution;
continuously stirring the first solution for 24-48 hours in a 30° C. water bath;
centrifugating the first solution and collecting precipitate;
rinsing collected precipitate with DI water and ethanol for at least 3 times; and
drying the collected sample at 80° C. for 10-15 hours.

16. The method of claim 15, wherein the method requires neither high-temperature treatment nor any other post-treatment.

17. The method of claim 15, wherein the hexagonal phase copper-cobalt Prussian blue analog material is capable of forming prism-shaped crystals.

18. The method of claim 15, the first solution further comprises one or more metal precursors.

19. The method of claim 18, wherein the one or more metal precursors comprise FeCl₃, NiCl₂, or ZnCl₂, or their hydrates.
